(19) United States
(12) Patent Application Publication
(10) Pub. No.: US 2006/0174541 A1
(43) Pub. Date: Aug. 10, 2006

(54) Tilt-latch assembly for a sash window

(76) Inventors: Vincent F. Eslick, Chicago, IL (US); Edward C. Flory, Crown Point, IN (US)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 11/296,854

(22) Filed: Dec. 7, 2005

Related U.S. Application Data
(60) Provisional application No. 60/633,908, filed on Dec. 7, 2004.

(51) Int. Cl. E05D 15/22

(52) U.S. Cl. 49/185

(57) ABSTRACT

A tilt-latch assembly (10) is used in a window assembly (11). The window assembly (11) has a sash window (12) slidable within a master frame (14) between a pair of guide rails (16), each guide rail (16) forming a shoe channel (17) having a channel base (18). The assembly includes a tilt-latch (40) having a housing (42) supported by the sash window (12) and having an outward end opening (53). The tilt-latch (40) also includes a latch bolt (46) having a distal end (60). The latch bolt (46) is slidably retained by the housing (42). The distal end (60) of the latch bolt (46) has an aperture (62). The assembly (10) also includes a retainer (41) having a leg (66) and a hook (70) spaced from the leg (66). The retainer (41) is fastened to the channel base (18). When the sash window (12) is in a closed position, the aperture (62) of the latch bolt (46) receives the hook (70) of the retainer (41).

### RELATED APPLICATIONS

The present application claims priority to and the benefit of U.S. Provisional Appln. No. 60/633,908, filed on Dec. 7, 2004, which application is incorporated by reference and made a part hereof.

### TECHNICAL FIELD

The invention relates to window hardware for windows slidable within a master frame, more specifically, it is related to a tilt-latch assembly for a sash window.

### BACKGROUND OF THE INVENTION

A pivotal sash window adapted for installation in a master frame of a sash window assembly is well known. The sash window is slidable within the master frame. Typically, tilt-latches are installed on or in the sash window and, along with other cooperating hardware, allow the sash window to be pivoted from the frame. One example of such a tilt-latch is shown in U.S. Pat. No. 6,155,615. In some sash window assemblies, excessive wind loads can cause certain tilt-latches to become disengaged from the master frame allowing unwanted pivoting and disengagement of the sash window from the master frame. This can result in damage to the window assembly and injury. While tilt-latches according to the prior art provide a number of advantageous features, they nevertheless have certain limitations.

The present invention is provided to solve the problems discussed above and other problems, and to provide advantages and aspects not provided by prior tilt-latches of this type. A full discussion of the features and advantages of the present invention is deferred to the following detailed description, which proceeds with reference to the accompanying drawings.

### SUMMARY OF THE INVENTION

A tilt-latch assembly is provided for a sash window assembly. The tilt-latch assembly has cooperative structure that resists loads on the sash window assembly to minimize or prevent unwanted sash window disengagement from the master frame.

A tilt-latch assembly is provided for use with a window assembly having a sash window slidable within a master frame between a pair of guide rails, each guide rail forming a shoe channel having a channel base. The assembly includes a tilt-latch having a housing adapted to be supported by the sash window and having an outward end opening. The tilt-latch also includes a latch bolt slidably retained within the housing and having a distal end slidable between an extended position and a retracted position. The distal end has an aperture therein. The assembly also includes a retainer having a leg adapted to be fastened preferably to the channel base and a hook spaced from the leg. In a closed window position, the aperture of the latch bolt receives the hook. The tilt-latch assembly provides increased resistances to wind loads experienced by the sash window assembly.

A tilt-latch assembly is provided for use with a window assembly having a sash window slidable within a master frame between a pair of guide rails, each guide rail forming a shoe channel having a channel base. The assembly includes a tilt-latch having a slidable latch bolt with an actuator. The latch bolt includes a proximal end and a distal end, and the latch bolt is slidable between an extended position and a retracted position. The distal end of the latch bolt includes an aperture. A spring biases the latch bolt into the extended position. A retainer having a leg is fastened to the channel base. The retainer includes a hook which is spaced from the leg. The aperture of the latch bolt receives the hook when the sash window is placed in a closed position.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a window assembly;

FIG. 2 is a front view of a mounted retainer of the present invention;

FIG. 3 is a perspective view of an unmounted retainer;

FIG. 4 is a top view of the retainer of FIG. 3;

FIG. 5 is a side view of the retainer of FIG. 3;

FIG. 6 is a front view of the retainer of FIG. 3;

FIG. 7 is a top view of a tilt latch housing of the present invention;

FIG. 8 is a bottom view of the tilt latch housing of FIG. 7;

FIG. 9 is a perspective view of a latch bolt of the present invention that is slidably supported in the tilt-latch housing of FIGS. 7-8;

FIG. 10 is a partial schematic top view of the tilt-latch assembly of the present invention installed in the window assembly of FIG. 1, with the sash window being in a closed position within the master frame; and,

FIG. 11 is a side view of the tilt-latch assembly of FIG. 10.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

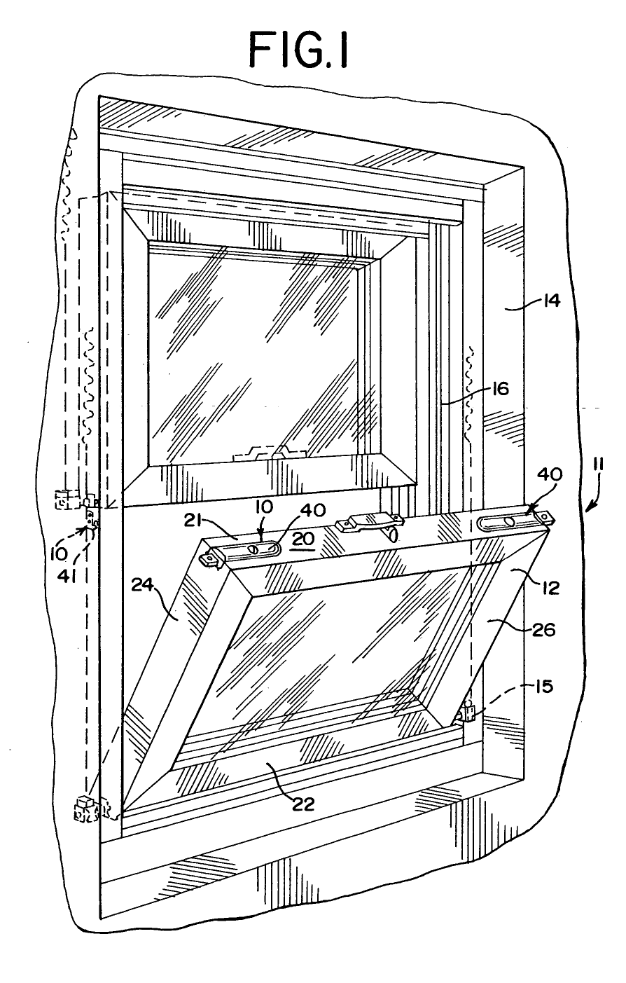

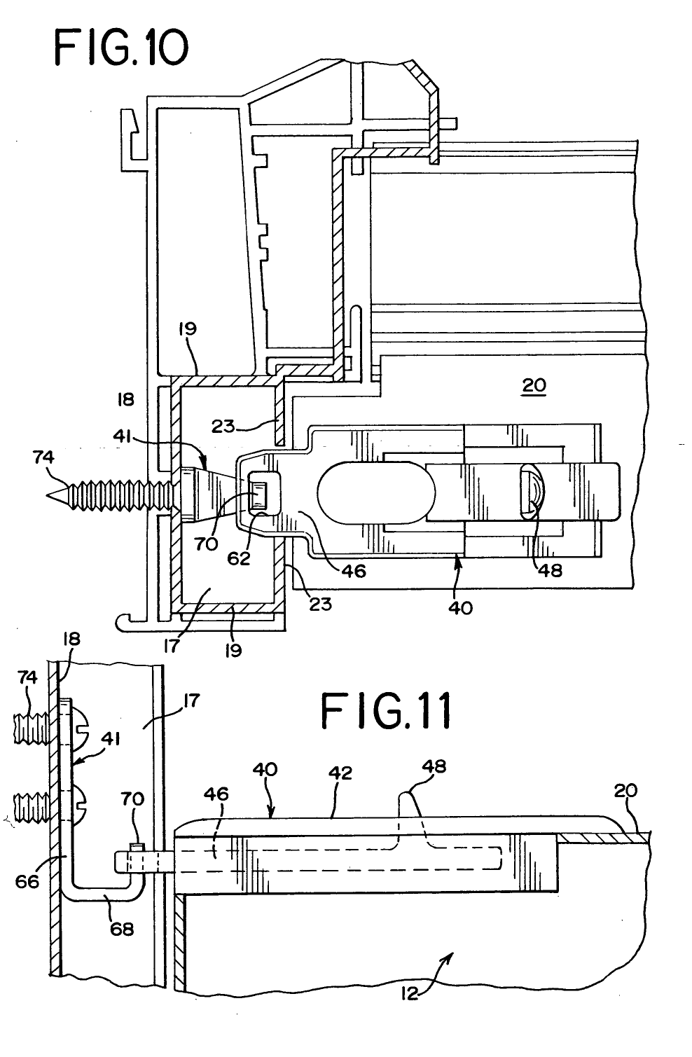

FIG. 1 shows a tilt-latch assembly of the present invention, generally designated with the reference numeral 10, used in a sash window assembly 11. The sash window assembly 11 shown in FIG. 1 is a double-hung window assembly having a pivotal sash window 12 installed in a master frame 14. The particular sash window assembly 11 shown in FIG. 1 is made from extruded vinyl although it could also be made from other materials including wood. The tilt-latch assembly 10 could also be used in all types of pivotal windows or structures. The sash window 12 is pivotally mounted to the master frame 14 by a sash balance/brake shoe assembly 15. As is well known, the master frame 14 has opposed, vertically extending guide rails 16 that form a shoe channel 17. As shown in FIG. 10, the shoe channel 17 includes a channel base 18, a pair of channel sidewalls 19 extending from the base 18, a pair of shoulders 23 extending inward from the sidewalls 19. It is understood that the base 18 can be defined on the other wall structures of the shoe channel 17. As further shown in FIG. 1, the sash window 12 has a top sash rail 20 having a top surface 21, a base 22 and a pair of stiles 24, 26, cooperatively connected together at adjacent extremities thereof to form a sash frame, typically rectangular although other shapes are possible. The tilt-latch portion of the tilt-latch assembly 10 is typically mounted to the top surface 21 of the top sash rail 20.

As shown in FIGS. 1 and 11, the tilt-latch assembly 10 generally comprises a tilt-latch 40 and a retainer 41. As previously discussed, the tilt-latch 40 is mounted in the top sash rail 20 of the sash window 12. The retainer 41 is mounted in the shoe channel 17. As will be discussed in greater detail below, the tilt-latch 40 and the retainer 41 have cooperative structure to enhance the overall operation of the sash window assembly 11.

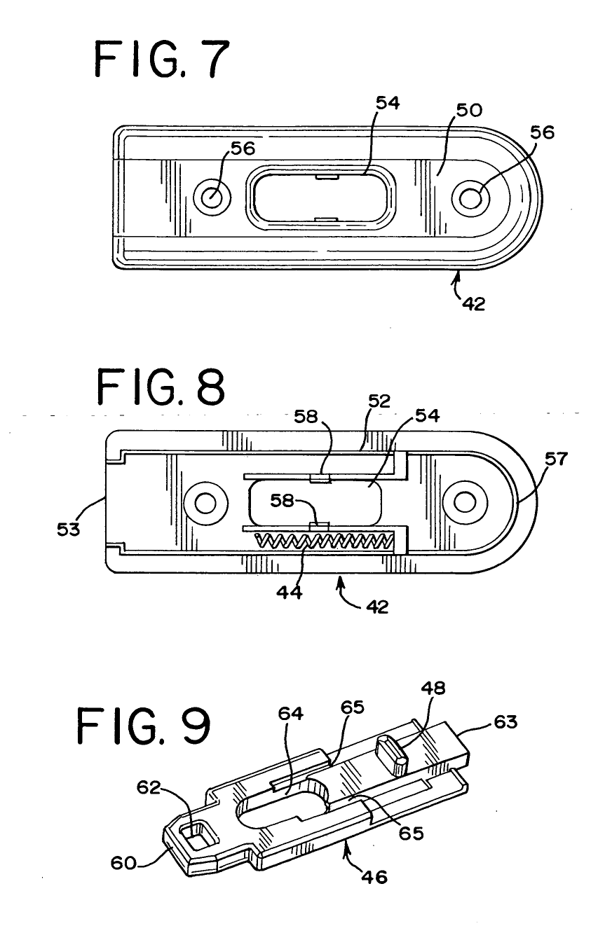

As shown in FIGS. 7-11, the tilt-latch 40 comprises a housing 42, a biasing spring 44 (shown schematically in FIG. 8), a latch bolt 46, and an actuator 48. The housing 42 is adapted to be supported by the top rail 20. The latch bolt 46 is disposed within the housing 42. The actuator 48 is connected to the latch bolt 46 and is designed to allow a user to retract the latch bolt 46 into the housing 42 against the biasing force of the spring 44. As shown, the actuator 48 is shown integrally formed with the latch bolt 46. However, it is understood that the actuator 48 may be a separate component of the tilt-latch 40 and attached to the latch bolt 46 by any of various means.

As shown in FIGS. 7 and 8, the housing 42 is of a top mount construction, although other configurations are possible, and includes a top wall 50 and two depending side walls 52 that define an outward end opening 53. The side walls 52 generally curve and meet to define a closed end 57. The top wall 50 includes a slot 54 and a pair of screw holes 56. The housing 42 further has a pair of opposed latch slides 58.

As shown in FIGS. 9-11, the latch bolt 46 is adapted to be slidably retained by the housing 42. The latch bolt 46 has an extended position (FIGS. 10-11) and a retracted position. The latch bolt 46 includes a distal end 60 having an aperture 62 and a proximal end 63 opposed from the distal end 60. The distal end 60 is relatively far from the closed end 57 of the housing 42, and the proximal end is relatively close to the closed end 57 of the housing 42. The distal end 60 is preferably tapered. The aperture 62 extends vertically through the latch bolt 46. While in one preferred embodiment the aperture 62 extends completely through the latch bolt 46, the aperture 62 could extend through a portion of the latch bolt 46. For example, the distal end 60 could be hollowed-out on one side of the latch bolt 46. The aperture 62 shown in FIG. 9 is generally oblong and in one preferred embodiment, the aperture 62 is rectangular. It is understood that other shapes can be used including squares, ovals, circles etc. Located between the distal end 60 and the proximal end 63 are the actuator 48 and a screw slot 64. The screw slot is generally elongated to allow sliding of the latch bolt 46 around a screw (not shown) or other fastener used to fasten the tilt-latch on the top rail 20.

As further shown in FIG. 9, the latch bolt 46 includes a pair of latch slots 65. The latch slots 65 receive the latch slides 58 of the housing 42. The latch bolt 46 and housing 42 cooperate to allow relative sliding movement between the latch bolt 46 and housing 42. It is understood that several structures can be employed to slidably support the latch bolt 46 within the housing 42. The latch bolt 46 and housing 42 are preferably symmetric along their respective central axes.

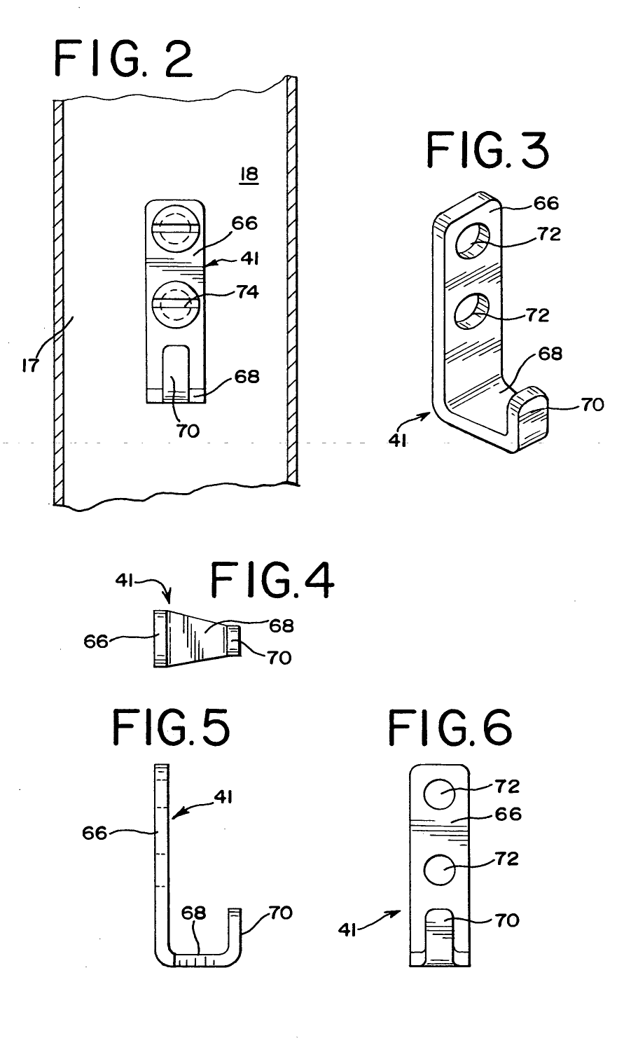

As shown in FIGS. 2-6, the retainer 41 is generally J-shaped and includes a leg 66, a base 68 and a protrusion 70, that may be referred to as a hook 70. The leg 66 includes a pair of spaced fastener holes 72. The base 68 extends generally perpendicularly from one end of the leg 66. The hook 70 is attached to the other end of the base 68 and generally extends in a direction parallel to the leg 66. As shown in FIG. 4, the base 68 generally narrows between the leg 66 and the hook 70. As shown in FIG. 11, the leg 66 and hook 70 extend vertically parallel to the channel base 18. It is understood that the retainer 41 can take many different forms, and the J-shape is but one preferred configuration.

To assemble the tilt-latch 40, the latch bolt 46 is inserted into the housing 42 such that the distal end 60 extends through the outward end opening 53, the screw slot 64 aligns with one of the screw holes 56 of the top wall 50, and the actuator 48 extends through the top wall slot 54 of the housing 42. The latch slides 58 snappingly and slidingly engage the latch bolt 46. The latch bolt 46 is then slidable between an extended position wherein the distal end 60 extends through the outward end opening 53 and a retracted position wherein the distal end 60 retracts towards the housing 42, such as for pivoting the sash window. Also, the spring 44 or other resilient member is preferably positioned between the proximal end 64 of the latch bolt 46 and the housing 42 to bias the latch bolt 46 towards its extended position.

The assembled tilt latch 40 is attached to the top surface of the top sash rail 20 by use of screws or other fasteners inserted through the screw holes 56 of the top wall 50 of the housing 42. Before doing so, the tilt latch 40 is positioned as generally shown in FIG. 1. It is further understood that other mounting structures could be incorporated on the housing 42. For example, flush-mount structure could be employed wherein the structure would cooperate with the top rail structure eliminating the need for separate screw fasteners through screw holes 56.

As seen in FIG. 10, the retainer 41 is attached in the shoe channel 17. In one preferred embodiment, the retainer 41 is mounted on the channel base 18. Specifically, the base 68 of the retainer 41 abuts against the channel base 18 and a screw or other fastener 74 is inserted through each fastener hole 72 to attach the retainer to the channel base 18. As generally seen in FIGS. 10 and 11, the retainer 41 is oriented within the shoe channel 17 such that the hook 70 points in a generally upward vertical direction. Also, the retainer 41 is located near a mid-point of a height of the guide rails 16, but in an appropriate position to cooperate with the tilt-latch 40 as described below.

In use, the sash window 12 is slidable within the master frame 14 between a closed position wherein the sash window 12 is fully lowered and an open position wherein the sash 12 is raised from the closed position. Also, it is understood that that the sash window 12 can be pivoted from the master frame 14. (FIG. 1) As the sash window 12 slides within the master frame 14, the distal end 60 of the latch bolt 46 extends into the shoe channel 17. When the sash window 12 is moved from an open position to its closed position, the aperture 62 of the distal end 60 receives the protrusion 70, or the hook 70. That is, a portion of the hook 70 extends through the aperture 62, although there need not necessarily be any contact between the hook 70 or any other portion of the retainer 41 and the latch bolt 46. As shown in FIGS. 10-11, in one preferred embodiment, the aperture 62 is larger than the protrusion 70 wherein a space is maintained between a surface of the protrusion 70 and a surface of the latch bolt 46 defining the aperture 62. It is further shown that when the sash window 12 is in the closed position, a top portion of the hook 70 extends past an upper surface of the latch bolt 46. Therefore, when the sash 12 is in its closed position, the distal end 60 of the latch bolt 46 and the retainer 41 are in an interference relationship with one another. More specifically, the retainer 41 will resist any lateral movement of the latch bolt 46 that may result from excessive wind conditions or from any object that may forcefully strike the window sash 12. This resists or prevents unwanted pivoting or disengagement of the sash window from the master frame 14.

Sash window assemblies are subject to forces when under high wind loads such as from severe thunderstorms, tropical storms, and hurricanes. The cooperative positional relationship between the latch bolt aperture 62 and the hook 70 provides resistance to such wind loads. It is understood that the dimensions of the aperture and hook could be modified as desired to provide full surface-to-surface contact or to vary the clearances between the hook 70 and an interior surface of the latch bolt as defined by the aperture 62.

It should be noted that in other respects the tilt-latch assembly 10 functions in a similar manner as many of the known tilt-latches. That is, when the sash 12 slides within the master frame 14, the distal end 60 of the latch bolt 46 extends into the guide rail 16 to maintain the sash 12 within the master frame 14, in a vertical, un-pivoted configuration. To tilt the sash 12 out of the master frame 14, the latch bolt 46 is moved to its retracted position by use of the actuator 48 thereby removing the distal end 60 from the guide rail 16, to allow the sash 12 to tilt. It is understood that the sash window 12 will be raised slightly such that the latch bolt 46 clears the hook 70 of the retainer 41. Thus, the aperture 62 no longer receives the hook 70. While being raised, the sash window 12 may still be considered to be in the closed position. The vertical length of the hook 70 could vary thus varying the amount that the sash window 12 must be raised for the latch bolt 46 to clear the hook 70. Of course, there is a tilt-latch assembly 10 located at each upper corner of the sash window 12, both of which would need to be so manipulated to permit tilting.

As discussed, the tilt-latch 40 and retainer 41 have cooperative structure that provide resistance from unwanted disengagement of the sash window 12 from the master frame 14. This structure is in addition to an outer surface of the distal end of the latch bolt 46 engaging the guide rails to maintain the sash window in an un-pivoted configuration. The cooperative structure includes one structure having a protrusion and one structure having a receiver. It is understood that either structure could include the protrusion and the receiver. For example, the latch bolt 46 could include a protrusion and the retainer 41 could include a receiver in the form of an aperture to receive the protrusion. In one preferred embodiment, however, the latch bolt 46 has the aperture 62 and the retainer 41 has the protrusion 70. In addition, the receiver may be formed by a circumferential structure that defines an opening, such as the receiver being formed by latch bolt structure forming the aperture 62. Regardless of the particular configuration employed, the protrusion 70 and aperture 62 cooperate as discussed above. Finally, it is further understood that the retainer 41 is preferably mounted in the shoe channel 17 so it can cooperate with the tilt-latch 40. The retainer 41 could be mounted in various ways included being incorporated into other balance assembly structure. The retainer 41 can be mounted on other walls of the shoe channel, but in a preferred embodiment, the leg 66 of the retainer 41 is mounted on the channel base 18. The retainer 41 could also be mounted such that the hook 70 is received by the aperture 62 from a top side of the latch bolt 46.

While the specific embodiments have been illustrated and described, numerous modifications come to mind without significantly departing from the spirit of the invention, and the scope of protection is only limited by the scope of the accompanying claims.

What is claimed is:

1. A tilt-latch assembly for use with a window assembly having a sash window slidable within a master frame between a pair of guide rails, each guide rail forming a shoe channel, the sash window having an open position and a closed position, the assembly comprising:
a tilt-latch adapted to be supported by the sash window, the tilt-latch having a latch bolt with a distal end, the latch bolt slidable between an extended position and a retracted position, the distal end having an aperture; and
a retainer adapted to be fastened in the shoe channel, the retainer having a protrusion,
wherein the aperture receives the protrusion when the latch bolt is in the extended position and the sash window is in the closed position.

2. The tilt-latch assembly of claim 1 wherein the retainer has a leg adapted to be fastened to the shoe channel, wherein the protrusion is spaced from the leg.

3. The tilt-latch assembly of claim 1 wherein the latch bolt includes latch slots and the tilt-latch has a housing that includes latch slides cooperatively engaged with the latch slots.

4. The tilt-latch assembly of claim 1 wherein the aperture is larger than the protrusion wherein a space is maintained between a surface of the protrusion and a surface of the latch bolt defining the aperture when the aperture receives the protrusion.

5. The tilt-latch assembly of claim 1 wherein when the aperture receives the protrusion, a top portion of the protrusion extends past an upper surface of the latch bolt.

6. The tilt-latch assembly of claim 1 wherein the aperture extends vertically through the latch bolt.

7. The tilt-latch assembly of claim 1 wherein the latch bolt is symmetrical along a central axis.

8. The tilt-latch assembly of claim 1 wherein the aperture extends completely through the latch bolt.

9. A tilt-latch assembly for use with a window assembly having a sash window slidable within a master frame between a pair of guide rails, each guide rail forming a shoe channel having a channel base, the sash window having an open position and a closed position, the assembly comprising:
a tilt-latch having a housing adapted to be supported by the sash window, the tilt-latch having a latch bolt slidably supported by the housing between an extended position and a retracted position, the latch bolt having a distal end having an aperture; and,
a retainer having a leg adapted to be fastened on the channel base, the retainer having a hook spaced from the leg,
wherein the aperture receives the hook when the latch bolt is in the extended position and the sash window is in the closed position.

10. The tilt-latch assembly of claim 9 wherein the aperture is larger than the protrusion wherein a space is maintained between a surface of the protrusion and a surface of the latch bolt defining the aperture when the aperture receives the protrusion.

11. The tilt-latch assembly of claim 9 wherein when the aperture receives the hook, a top portion of the hook extends past an upper surface of the latch bolt.

12. The tilt-latch assembly of claim 9 wherein the aperture extends vertically completely through the latch bolt.

13. A tilt-latch for use in a window assembly having a sash window slidable within a master frame between a pair of guide rails, each guide rail forming a shoe channel having a base, the window assembly having a retainer mounted in the channel base, the tilt-latch comprising:
a housing adapted to be supported by the sash window and having an outward end opening; and,
a latch bolt slidably supported by the housing between an extended position and a retracted position, the latch bolt having a distal end having an aperture, wherein the aperture is adapted to receive the retainer when the latch bolt is in the extended position and the sash window is in the closed position.

14. The tilt latch of claim 13 wherein the aperture extends vertically into the latch bolt.

15. The tilt latch of claim 14 wherein the aperture extends completely through the latch bolt.

16. The tilt latch of claim 13 wherein the aperture is generally oblong.

17. A retainer for use in a window assembly having a sash window slidable within a master frame between a pair of guide rails, each guide rail forming a shoe channel, the window assembly having a tilt-latch supported by the sash window, the tilt-latch having a latch bolt with an aperture, the assembly comprising:
a leg adapted to be fastened in the channel; and,
a hook spaced from the leg, wherein the hook is adapted to be received by the aperture when the sash window is in the closed position.

18. The retainer of claim 17 further comprising a retainer base positioned between the leg and the hook.

19. The retainer of claim 18 wherein the retainer base narrows between the leg and the hook.

20. The retainer of claim 17 wherein the leg includes a fastener opening, the opening adapted to receive a fastener that fastens the retainer to the channel base.

21. A tilt-latch assembly for use with a window assembly having a sash window slidable within a master frame between a pair of guide rails, each guide rail forming a channel, the sash window having an open position and a closed position, the assembly comprising:
a tilt-latch adapted to be supported by the sash window, the tilt-latch bolt having a latch bolt slidable between an extended position and a retracted position;
a retainer adapted to be fastened in the channel; and
cooperative structure between the latch bolt and the retainer, wherein one of the latch bolt and the retainer has a protrusion, and the other of the latch bolt and the retainer has a receiver, wherein the receiver receives the protrusion when the latch bolt is in the extended position and the sash window is in the closed position.

22. A window assembly comprising:
a master frame having a guide rail forming a channel having a base;
a sash window slidable along the guide rail, the sash window having an open position and closed position;
a tilt-latch having a housing connected to the sash window, the tilt-latch having a latch bolt slidably supported by the housing between an extended position and a retracted position, the latch bolt having an aperture at a distal end of the latch bolt; and
a retainer having a leg fastened to the base, the retainer having a hook spaced from the leg wherein the hook is received by the aperture when the latch bolt is in the extended position and the sash window is in the closed position.
